(19) United States
(12) Patent Application Publication
(10) Pub. No.: US 2007/0130000 A1
(43) Pub. Date: Jun. 7, 2007

(54) Marketing and rewards system and method

(76) Inventor: Ayman Assanassios, Bayside, NY (US)

Correspondence Address: OSTROLENK FABER GERB & SOFFEN, 1180 AVENUE OF THE AMERICAS, NEW YORK, NY, 100368403, US

(21) Appl. No.: 11/283,099

(22) Filed: Nov. 18, 2005

(51) Int. Cl. G06Q 30/00

(52) U.S. Cl. 705/14

(57) ABSTRACT

An apparatus and method for providing a marketing program for a selected group of merchants which provides incentives to consumers to purchase goods and/or services from the selected group of merchants. The method comprises establishing one or more merchant selection rules, registering a consumer wishing to participate in the program, receiving merchant information, matching the received merchant information with available merchant selection rules and adding merchants to one or more selected group of merchants after determining that the respective merchants have the required characteristics. A machine readable database operable to store specified information representing earned credits for participating consumers is provided. The program is universal in the sense that the method of payment is unrestricted and participating consumers receive an identification and which can be used for purchases from a participating merchant, in a store, by phone or online.

### FIELD OF THE INVENTION

The present invention relates generally to incentive rewards, and more particularly, to a system of marketing in which businesses receive marketing benefits by participation with a central provider that awards credits to consumers who purchase goods/services from the businesses.

### BACKGROUND OF THE INVENTION

Various incentive programs, such as those related to purchases, are known. Buyers of goods of services may receive coupons, rewards and/or points that can be redeemed for various forms of value. Decades ago, in the S&H GREENSTAMPS program, stamps were provided to consumers upon completing a purchase, such as for gasoline, etc. The stamps were redeemable for merchandise, described in a catalog distributed by S&H or at S&H Redemption Centers. In practice, the consumer redeemed his collection of S&H GREENSTAMPS by selecting an item that was available for the number of stamps being redeemed. The consumer selected the item, sent in or turned over his stamps, and the item was delivered to the consumer

Over time, S&H GREENSTAMPS were phased out. Fairly recently, S&H GREENPOINTS were introduced, which provides a somewhat modified and digital version of S&H GREENSTAMPS. In practice, a consumer registers over the internet to receive points in connection with purchases, typically, made over the internet. The registered consumer maintains an account on S&H Greenpoints' server, and, as used to be done with the S&H Greenstamps program, redeems the points for merchandise listed in a catalog (either provided on-line or on paper). S&H also allows grocery chains to issue cards for use at the issuing chain's stores.

Also known are plans by which consumers may accumulate points from using particular purchasing means or by providing specific club cards at the point of sale. For example, a credit card may offer awards points each time a consumer uses that credit card. Alternatively, an airline may provide points that are redeemable for free air travel after a consumer purchases airline tickets for that airline. In yet another example, a store may offer discounts each time the store's club card is presented at the point of sale.

Notwithstanding the existence of various rewards programs, many businesses are incapable of receiving a level of marketing they desire. Merchant-operated reward programs are not necessarily suitable for small businesses because the program is exclusive to a respective merchant. Such a program is, typically, useful for a larger businesses. Small-scale merchants, typically, cannot afford to operate an incentive-based or rewards program, and, accordingly, cannot afford competitive forms of marketing.

Moreover, most rewards programs provide rewards that originate from the same issuing identity. For example, United Air Lines offers free air travel on United Airlines. Further, even with prior art points and rewards programs, many consumers do not realize a benefit of selecting one merchant over another. In the above example, a consumer would be unable to fly USAir, and redeem free air travel from United Airlines.

### SUMMARY OF THE INVENTION

The present invention recognizes a need for an alternative incentive-related program that does not require a particular form of payment, such as a particular credit card, and does not limit where (i.e., online or in a store) the consumer must shop. The present invention is directed to a system and method for providing a marketing program for a selected group of merchants, i.e., those satisfying specific criteria. Each of the merchants participates with a program provider that provides incentives to consumers to purchase goods and/or services from the merchants. In exchange for participating in the program, merchants preferably pay a flat fee or a fee based on a percentage of sales to the program provider.

In a preferred embodiment, one or more merchant selection rules are established that includes characteristics required of any merchant to join one or more groups of merchants. The merchant selection rules can apply to any characteristics of merchants, such as a merchant's physical location, store size, inventory, number of employees, hours of operation, or the like. The merchant selection rules are preferably stored in a database, such as provided by an information processor and accessible over the internet.

Consumers who wish to participate in the program preferably register, for example, with an information processor that is operable as an internet web server. Consumers preferably provide at least a minimum amount of information, such as user name and password, in order to register with the information processor. Of course, one skilled in the art will recognize that the consumer can provide other information, as well, for example to improve marketing-related services associated with the present invention. Such information may include the consumer's age, gender, marital and/or financial status, demographics, purchasing preferences, likes and dislikes, or etc. Consumer information may be provided in the form of a questionnaire or other type of survey that, when completed, results in awarding the consumer bonus credits, which are redeemable in the same manner as those earned through purchases, as described in greater detail below.

In an alternative embodiment, consumers do not have to provide any registration information at all. Merely having possession of a card issued by the program would be sufficient for a consumer to receive and redeem rewards, in accordance with the present invention.

A merchant who desires to join a selected group of merchants transmits merchant information, preferably in machine-readable form, to the program provider. The merchant information includes characteristics of the respective merchants, such as the merchants' physical location, store size, inventory, or the like. Once received, the merchant information is matched with the merchant selection rules in the database and any merchants who are determined to have the required characteristics are added to the applicable selected group (or groups) of merchants for which the merchant qualifies.

In addition, the present invention preferably includes a machine readable database that is accessible on a communication network, such as the Internet, and is operable to store information representing earned credits for participating consumers. Credits are provided in response to transactions between participating consumers and participating merchants. For example, a consumer who purchases one hundred dollars worth of a merchandise from a participating merchant is entitled to a number of credits (e.g., 100 credits) that are redeemable for goods and/or services.

Preferably, access to the database is provided, for example, to update the database with information representing earned credits for a particular transaction that is independent of the method of payment for goods and/or services, and also independent of where the goods and/or services are offered for sale. Thus, a consumer who makes a cash purchase for goods sold at a participating merchant's store can earn credits in accordance with the teachings herein.

Also, preferably the invention comprises storing in the database incentives and respective values for the incentives relative to individual and/or cumulative sales transactions. Access to the data is provided for participating consumers to redeem incentives according to earned credits from purchases from the participating merchants. In certain contexts, consumers may not have an option to select from a group of rewards. For example, where legal, one option might be that the reward is in the form of a sweepstakes card, and the consumer does not have a choice to select a different reward over the sweepstakes card.

Other features and advantages of the present invention will become apparent from the following description of the invention, which refers to the accompanying drawings.

### BRIEF DESCRIPTION OF THE DRAWINGS

For the purpose of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 shows an example hardware arrangement in a preferred embodiment of the present invention;

FIG. 2 illustrates the functional elements of a user workstation and/or information processor;

FIG. 3 is a block diagram that illustrates an example networked arrangement of parties associated with the present invention;

FIG. 4 illustrates an embodiment of the present invention that shows example forms of payment that consumers can use to purchase goods and/or services;

FIG. 5 shows an embodiment of the present invention to illustrate the reception of information representing purchases;

FIG. 6 illustrates an example embodiment of the present invention that includes a plurality of participating merchants and a plurality of participating consumers;

FIG. 7 illustrates an embodiment of the present invention wherein merchants are associated with one or more merchant groups;

FIG. 8 represents an example layout of database table structures and corresponding relationships that may be included in an embodiment of the present invention;

FIG. 9 represents a consumer deciding to patronize a particular merchant for a purchase;

FIG. 10 is a flow chart that represents steps associated with a program provider defining and establishing merchant selection groups;

FIG. 11 is a flow chart that represents steps associated with a program provider establishing participating consumers;

FIG. 12 is a flow chart that represents steps associated with a program provider tracking purchases and maintaining consumer credit balances in accordance with an embodiment of the present invention;

FIG. 13 is a flow chart that represents steps associated with a merchant participating in a program in accordance with an embodiment of the present invention; and

FIG. 14 is a flow chart that represents steps associated with a consumer participating in a program in accordance with an embodiment of the present invention.

### DETAILED DESCRIPTION OF THE PREFERRED EMBODIMENTS

The present invention is directed to awarding credits to consumers who register with a program provider, and who purchase goods and/or services from a select group of merchants. Thus, the invention establishes an incentive and/or marketing program, and encourages consumers to register with the program provider, and to patronize the group of merchants. Preferably, a participating merchant displays a particular logo that identifies the merchant's participation in the program. To encourage consumers to patronize participating merchants, the consumers receive an accumulating reward or credit vis-à-vis each purchase from any participating merchant. Unlike typical prior art incentive programs, the present invention does not restrict consumers to any particular form of purchase. For example, users may purchase using cash, credit cards, checks, money orders or any other accepted form, and can earn credits from any of the participating merchants.

The present invention is applicable for a plurality of business. For example, the teachings herein are applicable for traditional “brick and mortar” businesses, as well as on-line (so-called e-commerce) businesses, TV shopping businesses, or virtually any other type of business.

The participating merchants have an advantage over non-participating businesses because participating merchants can receive marketing aid provided, at least in part, by the provider of the incentive program, and further by the consumers who benefit from the rewards provided herein. Also, satisfied consumers, e.g., those who benefit from the present invention, often provide word-of-mouth marketing for the participating merchants. Of course, one skilled in the art will recognize that other forms of marketing are envisioned herein, such as traditional forms including television, radio, internet and print advertising.

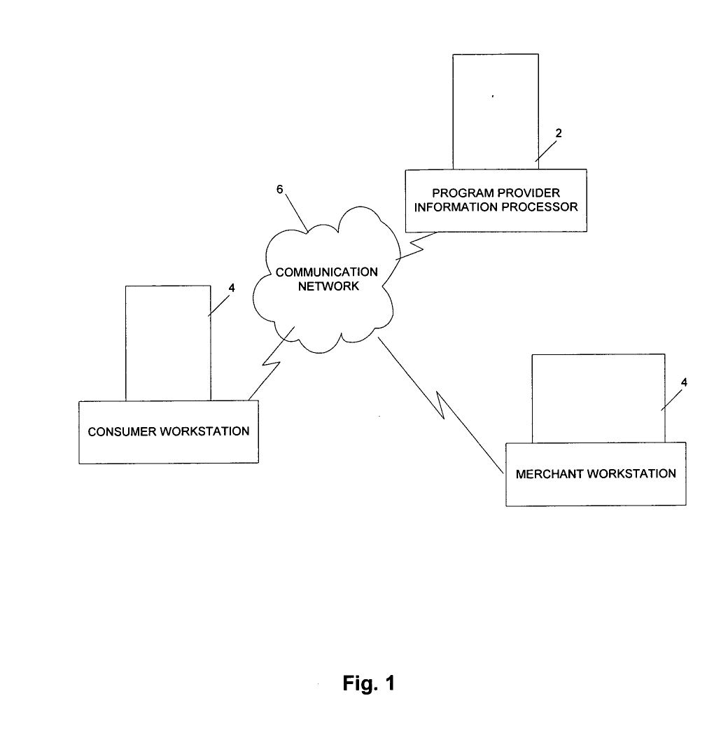

Referring to the drawings, in which like reference numerals refer to like elements, FIG. 1 shows an exemplary hardware arrangement in a preferred embodiment of the present invention, referred to generally as system 10. In the embodiment shown in FIG. 1, system 10 comprises at least one information processor 2 (configured to operate as an internet web server) adapted to access communication network 6 and communicate with user workstations 4. Preferably, user workstations 4 and information processor(s) 2 communicate via the known communications protocol, Transmission Control Protocol/Internet Protocol “TCP/IP.” In this way, content can be transmitted to and from the devices 2 and 4, and commands can be executed to enable the various functions described herein.

Information processors 2 and user workstations 4 are any devices that are capable of sending and receiving data across communication network 6, e.g., mainframe computers, mini computers, personal computers, laptop computers, a personal digital assistants (PDA) and Internet access devices such as Web TV. In addition, information processors 2 and user workstations 4 are preferably equipped with a web browser, such as MICROSOFT INTERNET EXPLORER, NETSCAPE NAVIGATOR, MOZILLA FIREFOX or the like. Thus, as envisioned herein, information processor 2 and/or user workstations 4 are devices that can communicate over a network and can be operated anywhere, including, for example, moving vehicles.

The nature of the present invention is such that one skilled in the art of writing computer executable code (i.e., software) can implement the described functions using one or more of a combination of popular computer programming languages and development environments including, but not limited to C, C++, Visual Basic, JAVA, PHP, HTML, XML, ACTIVE SERVER PAGES, JAVA server pages, servlets, and a plurality web site development applications.

For example, data may be configured in a MICROSOFT EXCEL spreadsheet file, as a comma delimited ASCII text file, as a MICROSOFT SQL SERVER compatible table file (e.g., MS-ACCESS table), or the like. In another embodiment, data may be formatted as an image file (e.g., TIFF, JPG, BMP, GIF, or the like). In yet another embodiment, data may be stored in an ADOBE ACROBAT PDF file. Preferably, one or more data formatting and/or normalization routines are provided that manage data received from one or a plurality of sources. In another example, data are received that are provided in a particular format (e.g., MICROSOFT EXCEL), and programming routines are executed that convert the data to another formatted (e.g., ASCII comma-delimited text).

It is contemplated herein that any suitable operating system can be used on user workstations 4 and information processor 2, for example, DOS, WINDOWS 3.x, WINDOWS 95, WINDOWS 98, WINDOWS NT, WINDOWS 2000, WINDOWS ME, WINDOWS CE, WINDOWS POCKET PC, WINDOWS XP, MAC OS, UNIX, LINUX, PALM OS, POCKET PC or any other suitable operating system. Of course, one skilled in the art will recognize that other software applications are available in accordance with the teachings herein, including, for example, via JAVA, JAVA Script, Action Script, Swish, or the like.

Moreover, a plurality of data file types is envisioned herein. For example, the present invention preferably supports various suitable multi-media file types, including (but not limited to) JPEG, BMP, GIF, TIFF, MPEG, AVI, SWF, RAW or the like (as known to those skilled in the art).

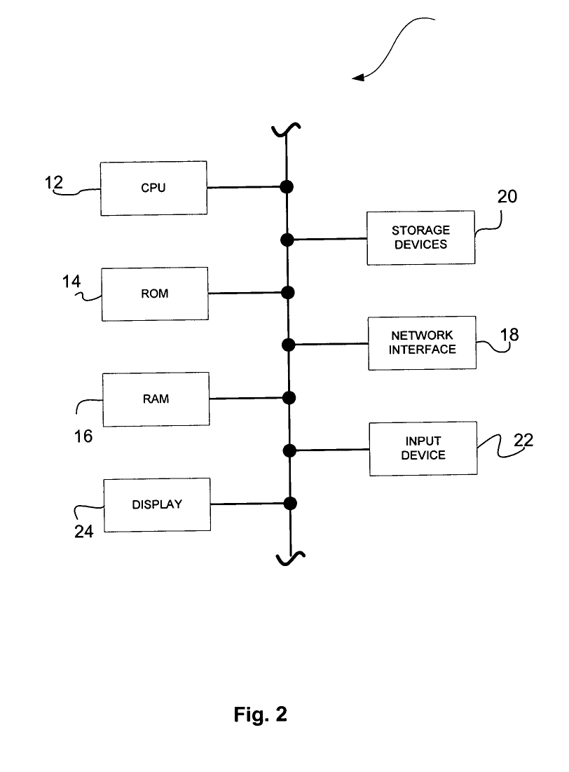

FIG. 2 illustrates the functional elements of user workstation 4 and/or information processor 2 that include one or more central processing units (CPU) 12 used to execute software code and control the operation of user workstation 4, read-only memory (ROM) 14, random access memory (RAM) 16, one or more network interfaces 18 to transmit and receive data to and from other computing devices across a communication network, storage devices 20 such as a hard disk drive, floppy disk drive, tape drive, CD ROM or DVD for storing program code, databases and application data, one or more input devices 22 such as a keyboard, mouse, track ball, magnetic card reading device, bar code reading device, microphone or the like, and a display 24.

The various components of information processor 2 and/or user workstation 4 need not be physically contained within the same chassis or even located in a single location. For example, storage device 20 may be located at a site which is remote from the remaining elements of information processor 2 or user workstation 4, and may even be connected to CPU 12 across communication network 6 via network interface 18. Information processor 2 preferably includes a memory equipped with sufficient storage to provide the necessary databases, forums, and other community services as well as acting as a web server for communicating hypertext markup language (HTML), FLASH, Action Script, Java, Active Server Pages, Active-X control programs on user workstations 4. Information processors 2 are arranged with components, for example, those shown in FIG. 2, suitable for the expected operating environment of information processor 2. The CPU(s) 12, network interface(s) 18 and memory and storage devices are selected to ensure that capacities are arranged to accommodate expected demand.

As used herein, the term, “module” refers, generally, to one or more discrete components that contribute to the effectiveness of the present invention. Modules can operate alone, or, alternatively, depend upon one or more other modules in order to function.

Also as used herein, the term, “merchant” refers, generally, to any party who sells a good or service. A participating merchant, in contrast, refers to any merchant that participates in a program provided by a program provider in accordance with the teachings herein.

Also as used herein, a “consumer” refers, generally, to any party that may purchase a good or service. A participating consumer, in contrast, refers to a consumer who receives credits or other benefit in accordance with the teachings herein. A participating consumer may be an individual, a business, or a plurality of consumers.

Also as used herein, the term, “credit” refers, generally, to an indicium of reward entitlement issued in connection with the present invention. For example, a participating consumer may receive ten credits for making a fifty-dollar purchase. Accumulated credits are redeemable for goods or services made available by the program provider. As envisioned herein, goods and services can include, for example, cash and/or sweepstakes cards.

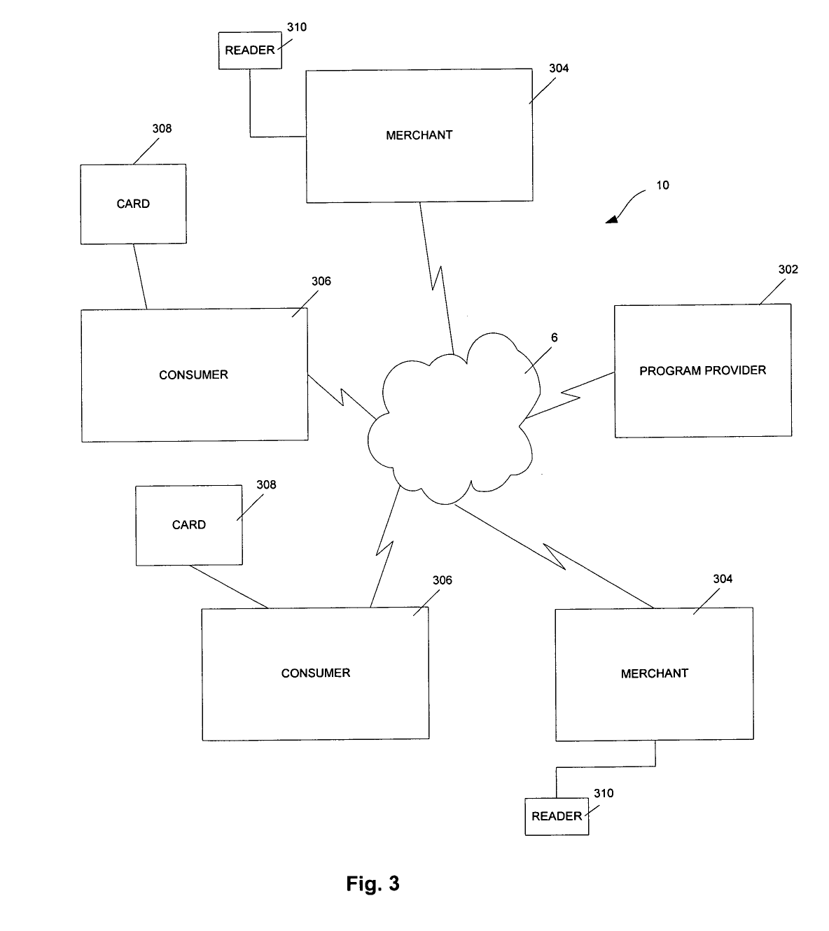

FIG. 3 is a block diagram that illustrates an example networked arrangement of parties associated with the present invention. As noted above with reference to FIGS. 1 and 2, the present invention is operable over one or more communication networks, such as the Internet, a wide area network, a local area network or the like. Thus, the present invention enables various parties to communicate information to each other that is useful or necessary to execute the teachings herein. One skilled in the art will recognize that the internet enables the convenient and rapid exchange of information, thereby enabling parties to transmit information regarding purchases made by participating consumers from participating merchants.

Continuing with reference to FIG. 3, program provider 302 implements many of the teachings herein, preferably via exercising control over information processor 2. Preferably, a program provider 302 establishes at least one merchant selection rule that includes a merchant-related characteristic required of merchants for participation with the program established by the program provider 302. Merchants that satisfy the criteria register with program provider 302 and become participating merchants 304 in accordance with the teachings herein. Consumers who register with program provider 302 become participating consumers 306, according to the present invention. Merchants 304 can participate in one or more classifications, as explained below.

In practice, program provider 302 promotes participating merchants 304. In part, this is accomplished by providing merchants 304 with a logo that is shared by participating merchants 304. The logo provides an indication that merchants 304 are participating in a rewards program, substantially as described herein, and the logo is preferably prominently displayed, such as in a merchant's window or door. Moreover, program provider 302 preferably advertises the program to consumers 306, including the ability to receive credits that are redeemable for one or more goods, and that accumulate from purchases made from participating merchants 304. Program provider 302 may advertise in print, television, radio, and/or web sites listed on the internet.

Preferably, program provider 302 employs information processor 2 to track purchases made by participating consumers 306, identified, for example, by use of card 308. Card 308 preferably carries some data, for example, via a magnetic strip placed on the card, or by a microchip embedded in the card. Alternatively, card 308 contains an identification number that merchant 304 and/or consumer 306 transmits to program provider 302. The identification number on the card is used to associate consumer 306 with the purchase. As noted above, consumer 306 may remain anonymous, without revealing his identity. In such a case, the consumer 306 physically presents his card in order to be eligible to redeem an incentive.

In one embodiment, a consumer registers with program provider 302 by providing at least a minimum amount of information, such as a user name and password. In a preferred embodiment, however, consumers 306 are prompted to provide more detailed information. As an incentive to provide the additional information, the consumer may be offered bonus credits equivalent to some level of purchase value. For example, an on-line data entry form may be provided to consumers 306 which includes textboxes for the consumer to submit information regarding demographics (e.g., age, gender, physical or mail address, e-mail address or the like), preferences (such as product preferences, shopping preferences or the like) or any other information that program provider 302 may find useful to improve the quality of the program provided thereby. After consumer 306 submits the information, the bonus credits are added to the consumer's credit account. Moreover, consumer 306 may be periodically prompted to update personal information to maintain accuracy. As noted above, consumer 306 may remain anonymous.

Program provider 302 may be a commercial entity and can enlist to merchants 304 to be partners as a respective sales force. Program provider 302 may charge an amount to merchants 304 for participation, such as a flat fee that entitles merchants 304 to participate for a fixed period of time. Alternatively, program provider 302 may charge merchants 304 a percentage of the amount of each purchase made to consumers 306.

Alternatively, program provider 302 may use dealers or representatives to sell goods or services for program provider 302 in exchange for a fee or commissioned percentage. Moreover, program provider 302 may enable merchants 304 to franchise a business of provider 302. Regardless of the precise business arrangement established between program provider 302 and merchant 304, it is preferred that a contract is executed between program provider 302 and merchant(s) 304 in order to bind the parties for a renewable certain time.

In one embodiment, cards 308 are provided to consumers 306 by merchants 304. The cards are activated following a first transaction with a participating merchant 304. Cards 308 may be provided in other ways, such as distributed or directly by program provider 302. Alternatively, consumer 306 can print out a card 308 on his or her computer printer. Cards obtained from merchants 304, or program provider 302, may contain magnetic strips or bar codes, in addition to numeric or alphanumeric codes representing a respective participating consumer 306. This may include the identity of consumer 306, or may merely include an anonymous identifier representing consumer 306.

When consumer 306 makes a purchase from merchant 304, consumer 306 preferably provides his card 308 together with payment in order to register the purchase and earn credits. Card 308 is preferably read by a reader 310 (i.e., “swiped”) and the card's information is transmitted to information processor 2 under the control of program provider 302. Program provider 302 adjusts the consumer's 306 credit account, for example, based on the amount of the transaction. Preferably, some form of feedback is received from information processor 2, such as an indication of the credit or consumer's 306 current credit balance.

Although the present invention has been described up to now by way of example with particular reference to cards 308, the invention is not so limited. For example, consumer 306 may be assigned an identifier (such as an identification number) by program provider 302, and no card 308 may be issued to the consumer. Consumer 306 may simply provide his identification number to a merchant after making a purchase. Alternatively, the consumer 306 may transmit his respective identifier to program provider 302, for example, over the internet. Thus, card 308 is a preferable feature of the present invention, although not required. For example, in case of an e-commerce or other remote form of purchase in which a consumer 306 is not physically present with a merchant 304, the consumer 306 submitting his identification number may register a purchase transaction.

The number of credits provided to consumer 306 in response to a purchase is preferably related to the size of the expense. For example, a large purchase will net consumer 306 a higher number of credits than a small purchase.

In one embodiment, after a certain amount of credits are earned, (e.g., 100, 500, 1000, etc.) the credits become eligible for redemption. The redeemed good/service may be in the form of a direct rebate for example cash, a check, future purchase credit, or gift card, or credits may be redeemed for goods and/or services listed in a printed or online catalog, sweepstake or a scratch card (where legal), which will indicate the value of the award(s). Preferably, sweepstakes cards for varying amounts of potential winnings are provided in accordance with a consumer's 306 credit account balance. For example, 50 credits may entitle a consumer 306 to a sweepstakes card with a potential prize of $1,000 in cash or prizes. Alternatively, 500 credits may entitle a consumer 306 to a sweepstakes card with a potential prize of $10,000 in cash or prizes. In this embodiment, merchant 304 or consumer 306 may be prompted to redeem the accumulated credits. In yet another embodiment, a consumer 306 may opt for sweepstakes cards having different possible values as opposed to a fixed value.

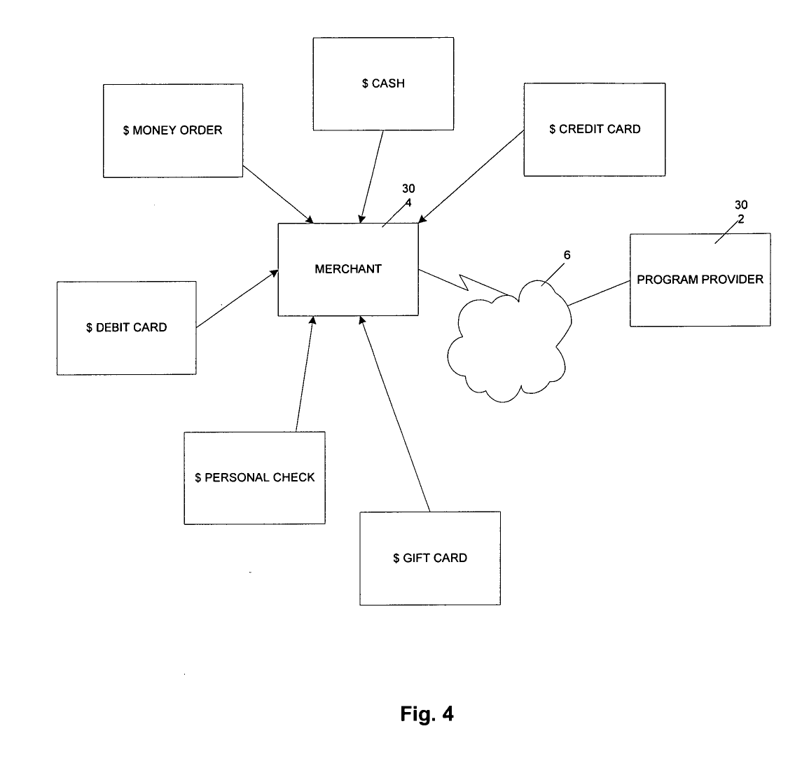

FIG. 4 illustrates an embodiment of the present invention that shows example forms of payment that consumers 306 can use to purchase goods and/or services from merchants 304 and earn credits in accordance with the present invention. For example, and as shown in FIG. 4, merchants 304 can accept a money order, cash, credit card, a debit card, a personal check, and/or a gift card for payment of a good and/or service sold by merchant 304. As noted above, program provider 302 receives details, for example, from merchants 304 or consumers 306, regarding purchases that entitle consumers 306 to credits. As noted above, each consumer's credit balance is tracked and updated in accordance with each respective purchase of goods/services sold by participating merchant 304.

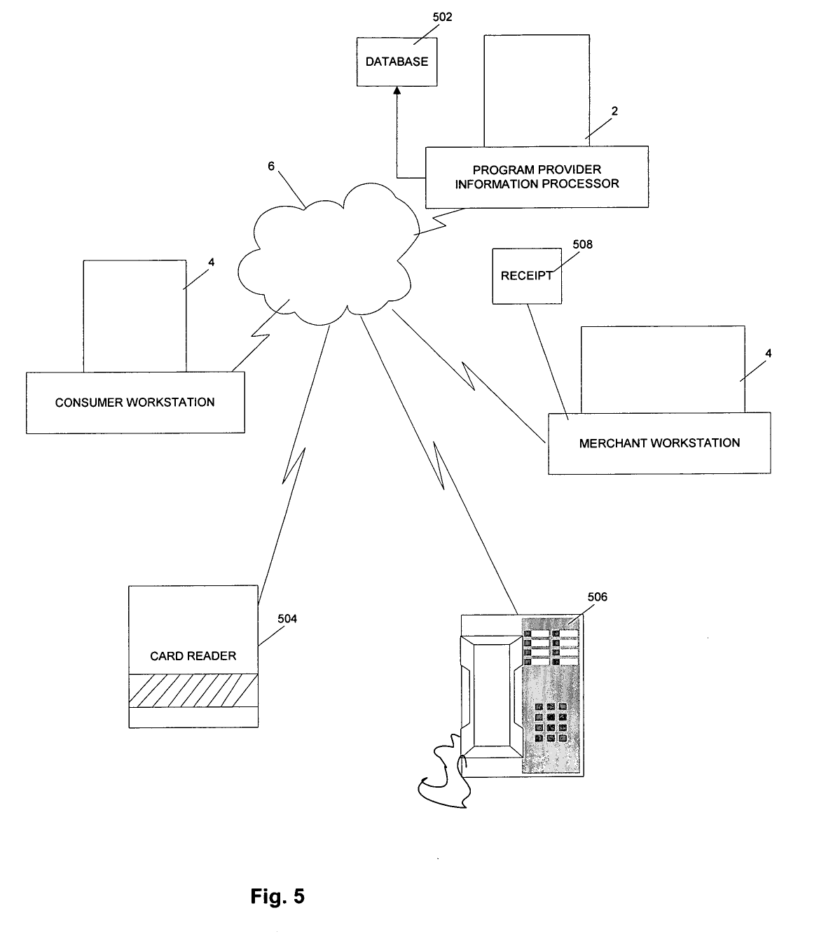

FIG. 5 shows an embodiment of the present invention to illustrate the flow of information representing purchases made and credits earned in accordance with the teachings herein. As shown in FIG. 5, database 502 is maintained on information processor 2 and used to store information regarding purchases, credits and redeemed goods/services. For example, database 502 may include information representing merchants 304, consumers 306, cards 308, consumer 306 balance of credits, redeemable goods/services, or the like. As noted above, information is preferably can be transmitted to program provider 302 in various ways. For example, merchant 304 may use a card reader 504 to extract information from card 308 identifying consumer 306, and then may transmit the information with information regarding a purchase by use of a workstation connected to the internet. Provider 302 thereafter updates database 502 and registers the purchase.

Alternatively, merchant 304 and/or consumer 306 may use telephone 506 to transmit information to program provider 302, such as by a voice response application or other known system using telephones 506. Alternatively, consumer 306 may use his home workstation 4 to transmit information regarding a purchase to program provider 302 (via information processor 2). Consumer 306 may also use workstation 4 and/or telephone 506, for example, to receive information regarding his account, and/or to redeem credits for goods and/or services. Preferably receipt 508 is provided to consumer 306 following a purchase, and receipt 508 contains information, such as an identifier, which is used to enable program provider 302 to track and store a purchase made by consumer 306.

As noted above, the merchant selection rule enables a merchant to join a select group of merchants, and may include virtually any characteristic of one or more merchants. Examples of possible characteristics include a merchant's physical store location, number of employees, store size, type of inventory, hours of operation, or the like. The selection rule can include multiple criteria, as well. The merchant selection rule is preferably stored in database 502, or is otherwise maintained by program provider 302.

When a merchant desires to participate in the program, or is solicited by program provider 302, after it is confirmed that the merchant possess the required characteristic for group membership, the merchant's status as a participating merchant 304, can become effective. For example, if the sole required characteristic is that a merchant be physically located in a geographic area, for example, within a three-block radius of a particular street intersection, any merchant within the three-block radius would be entitled to join a group of selected merchants and participate with the program provider 302. Such a rule may be desirable, for example, to encourage consumers 306 to patronize merchants in a particular neighborhood in order to promote a locality, and could result in solicitation by program provider 302.

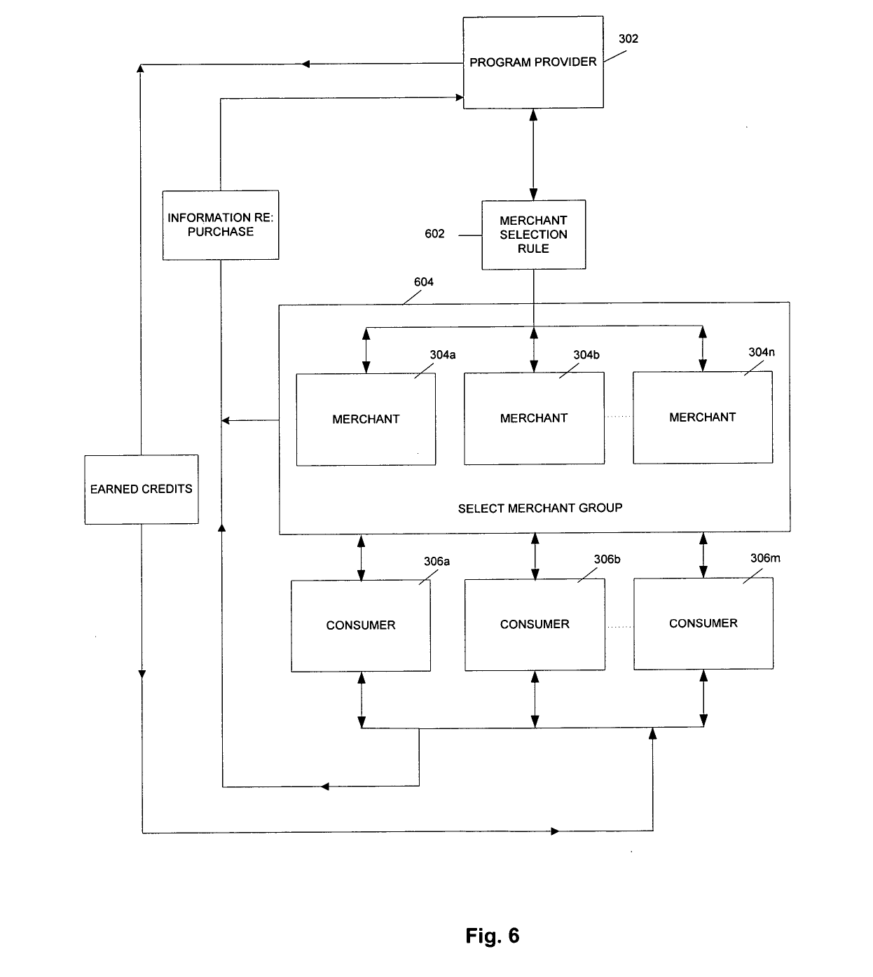

FIG. 6 illustrates an example embodiment of the present invention that includes a plurality of participating merchants 304a-304n and a plurality of participating consumers 306a-306m. Each of the plurality of merchants 304a-304n possesses characteristic(s) required by merchant selection rule 602, thereby entitling it to join selected group of merchants 604. As shown in FIG. 6, program provider 302 preferably establishes rule 602 associated with forming group 604, such as by requiring merchants to possess one or more characteristics. As shown in FIG. 6, purchases of goods/services are made by consumers 306 from one of merchants 304a, 304b. After a consumer 306 completes a particular transaction, information is transmitted to program provider 302, and credits are issued to the consumer 306 who made the purchases.

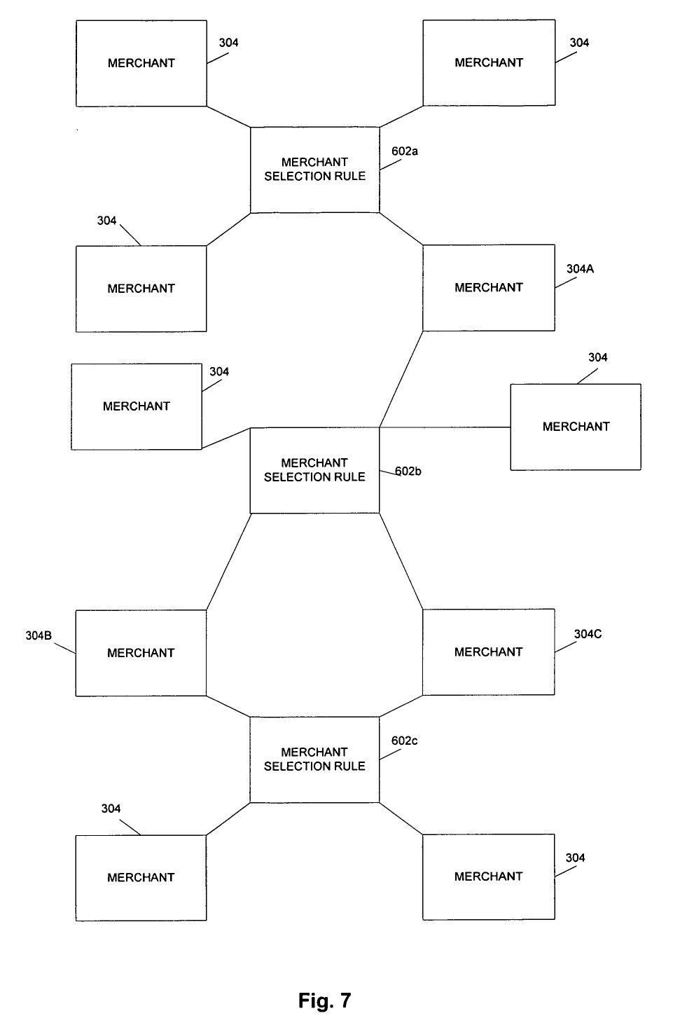

Although the embodiment illustrated in FIG. 6 represents a merchants group 604 comprising merchants that satisfy a single selection rule 602, the invention is not so limited. FIG. 7 illustrates an embodiment of the present invention wherein a merchant can be associated with one or more merchant group. In the example shown in FIG. 7, three merchant selection rules 602a-602c are shown, each with corresponding merchants 304 that satisfy the rules by possessing characteristic(s) required of the rules. Three merchants (304A, 304B and 304C) are each members of two merchant selection groups. Specifically, merchant 304A meets requirements of Rules 602a and 602b, and merchants 304B and 304C meet the requirements of Rules 602b and 602c. For example, a first merchant selection rule 602a may require that a merchant's store location be within a three-block radius of a particular street intersection. A second merchant selection rule 602b may require that a merchant includes used-books in its product inventory. Merchant 304A is located within the three-block radius, and sells used-books among its inventory. Therefore, merchant 304A satisfies both selection rules 602a and b and is a member of two merchant groups.

Moreover, the present invention supports an embodiment providing various respective programs among various respective merchant groups 604. For example, a $50 purchase from a merchant within a particular geographic location may entitle a consumer to X credits, while a $50 purchase from a merchant who sells used-books may entitle the consumer to Y credits. Preferably, information processor 2 under the control of program provider 302 tracks purchases and credits, even when provided in accordance with respective programs such as described above. Thus, continuing with reference to FIG. 7, a consumer who patronizes merchant 304A may be entitled to more credits for a purchase than he would had he purchased the same goods/services from another merchant 304 belonging to the same merchant group 604. Program provider 302 may award the higher number or lower number of credits (e.g., X or Y number of credits) in accordance with a predetermined policy.

As noted above, program provider 302 preferably tracks purchases, credits and redeemed credits for merchants 304 and consumers 306 in database 502. Database 502 may be formatted in many different ways. For example, database 502 may simply consist of a single spreadsheet, or, preferably, may comprise a robust relational database application comprising tables, structured query language (“SQL”) statements, data entry forms, summary and detailed data reports or the like. Database 502 is preferably accessible over communication network 6.

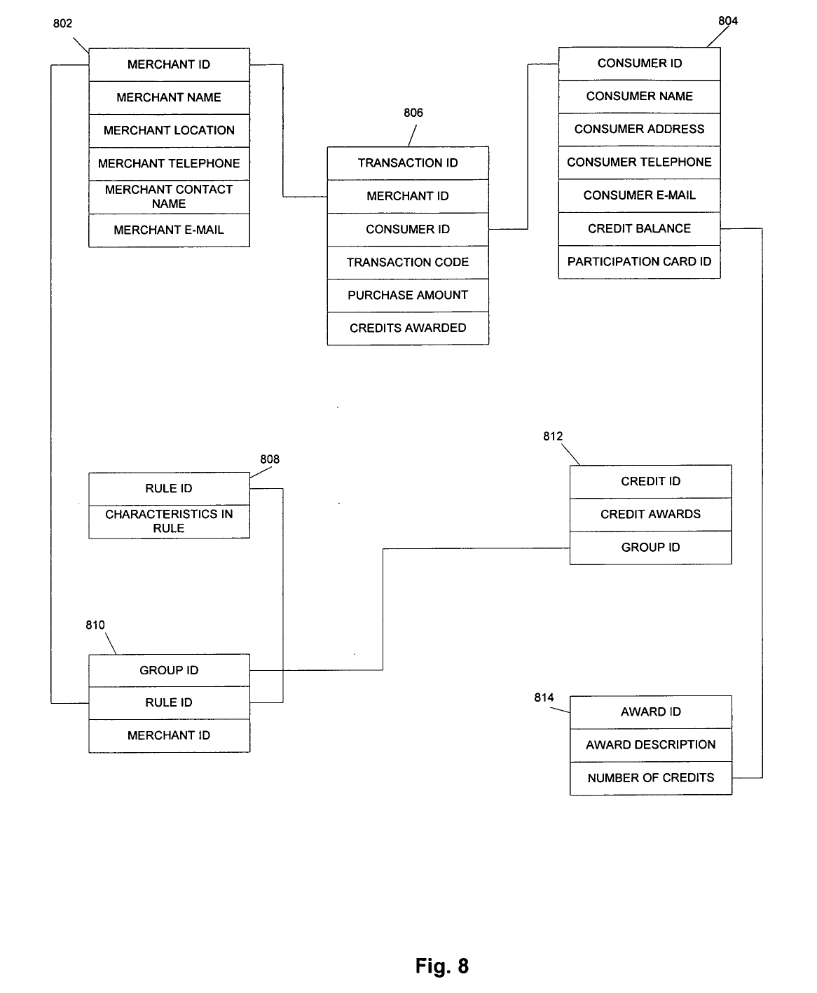

FIG. 8 represents an example layout of database table structures and corresponding relationships that may be included in an embodiment of the present invention. The tables in FIG. 8 preferably represent database tables, such as provided by MICROSOFT SQL SERVER, but may comprise any kind of database, such as those that support the open database connectivity (“ODBC”) standard. Preferably, database 502 is operable to store and manage data related to merchants 304 and consumers 306, cards 308, as well as purchases, credits, and redeemed awards.

Still referring to FIG. 8, merchant table 802 preferably contains merchant 304 related information, such as a merchant identification key, name, location, telephone, contact information and merchant e-mail information. Consumer table 804 preferably contains consumer 306 related information, including for example, a consumer identification key, consumer name, address, telephone e-mail information, credit balance and card number.

Continuing with the example database 502 illustrated in FIG. 8, transaction information table 806 preferably contains transaction information related to purchases, and includes, for example, a transaction identification key, merchant id (linked to merchant table 802), consumer id (linked to consumer table 804), transaction code, purchase amount, purchase date, and credits awarded. Merchant selection rule table 808 preferably contains information representing merchant selection rules and characteristics required of the rules including a rule identification key and selection characteristics required of a rule (e.g., physical location, inventory, store size, etc.) Merchant select group table 810 preferably contains information regarding selected merchant groups including a group identification key, rule id (linked to merchant selection rule table 808) and merchant id (linked to merchant table 802). Credits table 812 preferably includes information regarding awarding credits to consumers 306, including a credit identification key, credit awards and group id (linked to merchant select group). In this way, respective groups of merchants may award an amount of credits for a particular purchase that is different from another group of merchants for the same purchase.

Also included in database 502 shown in FIG. 8 is credit awards table 814 which preferably includes information regarding the awards available for various amounts of credits. For example, table 814 includes an award identification key, a description and photograph of a reward, and the number of credits required to redeem a respective reward.

One skilled in the art will recognize that the table structures defined in FIG. 8 are intended to be illustrative, and that other ways of defining database 502 are within the scope of the invention. Virtually any way information processor 2 (under the control of program provider 302) is able to track and monitor events related to purchases, credits, and/or redeeming credits is considered within the scope of the present invention.

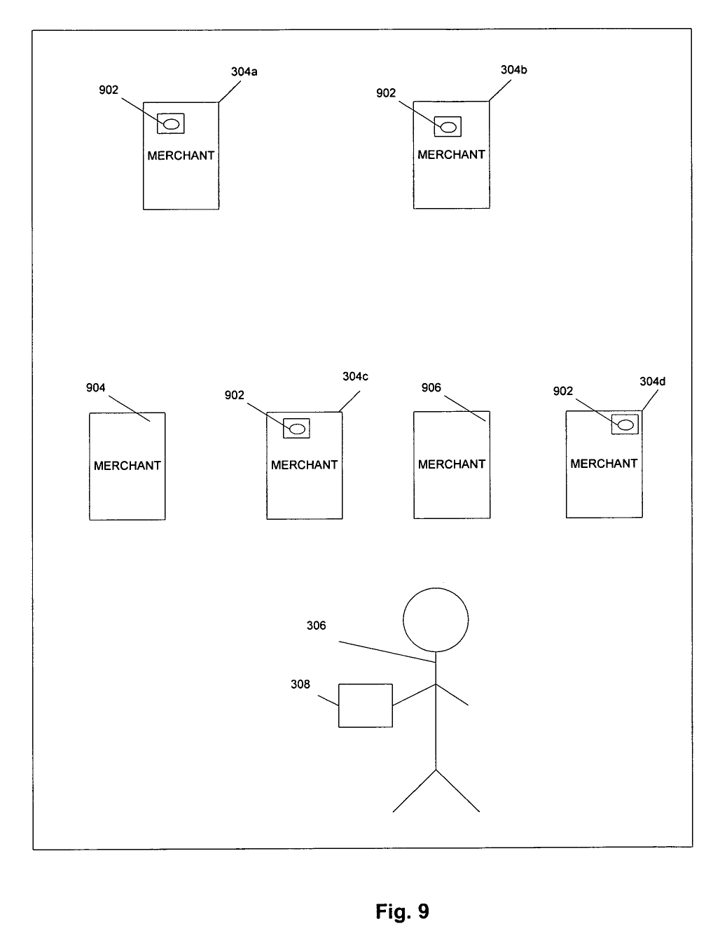

In practice, the present invention provides a marketing program for both merchants 304 and consumers 306. FIG. 9 illustrates a scenario in which a consumer 306 is deciding to patronize a particular merchant for a purchase. FIG. 9 illustrates four participating merchants 304a-304d and two non-participating merchants 904 and 906. Consumer 306 recognizes that merchants 304a-304d participate with the marketing program of the present invention because these merchants display logo 902 that identifies the merchants as participating members. Alternatively or in addition, consumer 306 can be made aware of merchants 304a-304d by various marketing and/or advertising strategies employed by program provider 302, such as by television advertising, radio advertising, and advertising in print, or by using internet technologies to advertise, such as described above. All of this is directed to enhancing the likelihood that consumer 306 will patronize a participating merchant 304a-304d rather than a non-participating merchant 904 or 906. Accordingly, the present invention provides a marketing program for merchants and consumers that results in benefits to both.

The present invention is now further described with reference to three examples.

### EXAMPLE 1

A consumer 306 wants to buy a camcorder that is sold for the same price by a non-participating merchant 904 as well as by a participating merchant 304a. Since merchant 304a is a participating member of program provider 302 and carries the logo 902, consumer 306 elects to purchase the camcorder from merchant 304a in order to take advantage of the rewards offered by program provider 302.

### EXAMPLE 2

A consumer, Steve, is accustomed to eating lunch at any one of six restaurants near the company where he works. Eventually, two of those restaurants display logo 902 provided by program provider 302, thereby indicating that the two restaurants are participating merchants. Steve, thereafter, decides to participate in the program offered by program provider 302, and thereafter eats lunch exclusively at one of the two participating restaurants. After each lunch, Steve, provided his card 308 and accumulated credits. Eventually, Steve redeems his earned credits for a sweepstakes card and wins $10,000.00. He still eats lunch at the two participating restaurants.

### EXAMPLE 3

A consumer 306, Mary, decides to book a vacation over the internet. While reviewing various popular internet travel web sites, Mary discovers that only one displays logo 902, thereby identifying that particular travel web site as a participating merchant. Accordingly, Mary decided to book with the respective on-line travel agent 304 to take advantage of the program and earn credits.

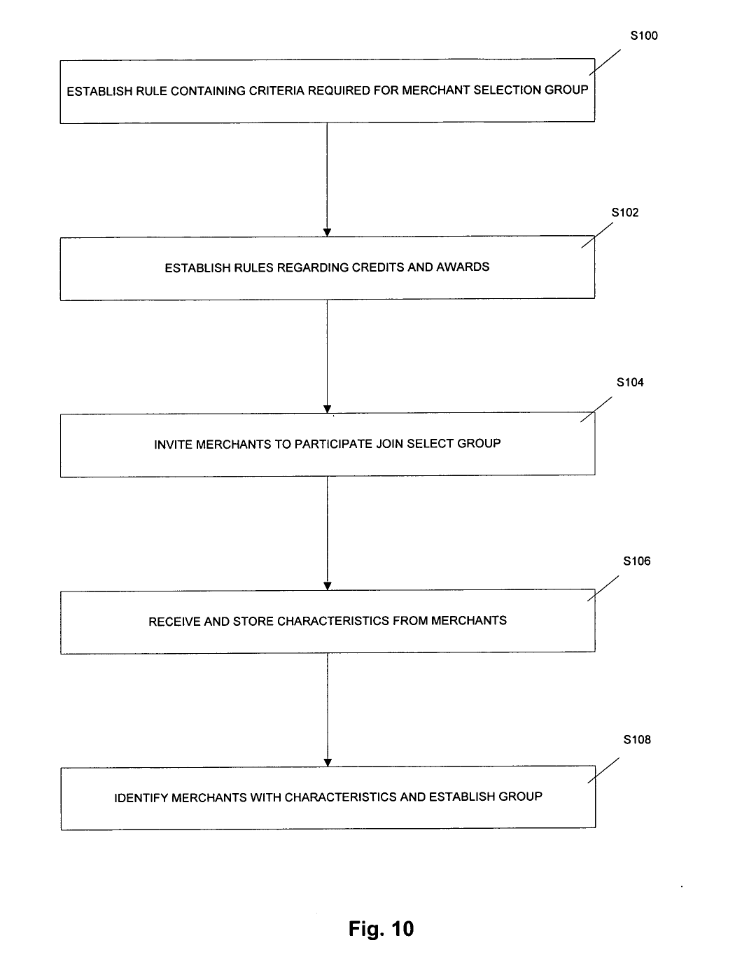

The present invention is now further described with reference to flow charts shown in FIGS. 10-14, as well as the drawings previously described.

FIG. 10 is a flow chart that represents steps associated with a program provider 302 defining and establishing merchant selection groups in accordance with an embodiment of the present invention.

In step S100, program provider 302 establishes a rule that includes a criterion or criteria of merchants required for merchants to join a select group of merchants. For example, the rule identifies a particular geographic location and maximum number of employees that a merchant must have in order to join the select group. In addition to establishing rules for select groups of merchants, program provider 302 establishes rules regarding the numbers of credits provided for purchases from participating merchants according to their respective groupings (step S102). Further, program provider 302 establishes awards that are provided when a consumer 306 redeems his credits.

Continuing with reference to the flowchart in FIG. 10, in step S104 program provider 302 invites merchants to join the defined selected group of merchants. This may be done, for example, by media advertising (e.g., television, radio, and printed publications), personally visiting merchants, or by advertising over the internet. Merchants that desire to join the select group preferably transmit information to program provider 302 that identify characteristics about the merchants, and program provider 302 preferably stores the information in database 502 (step S106). Those merchants that have the required characteristic are identified and the available groups of merchants are populated (step S108).

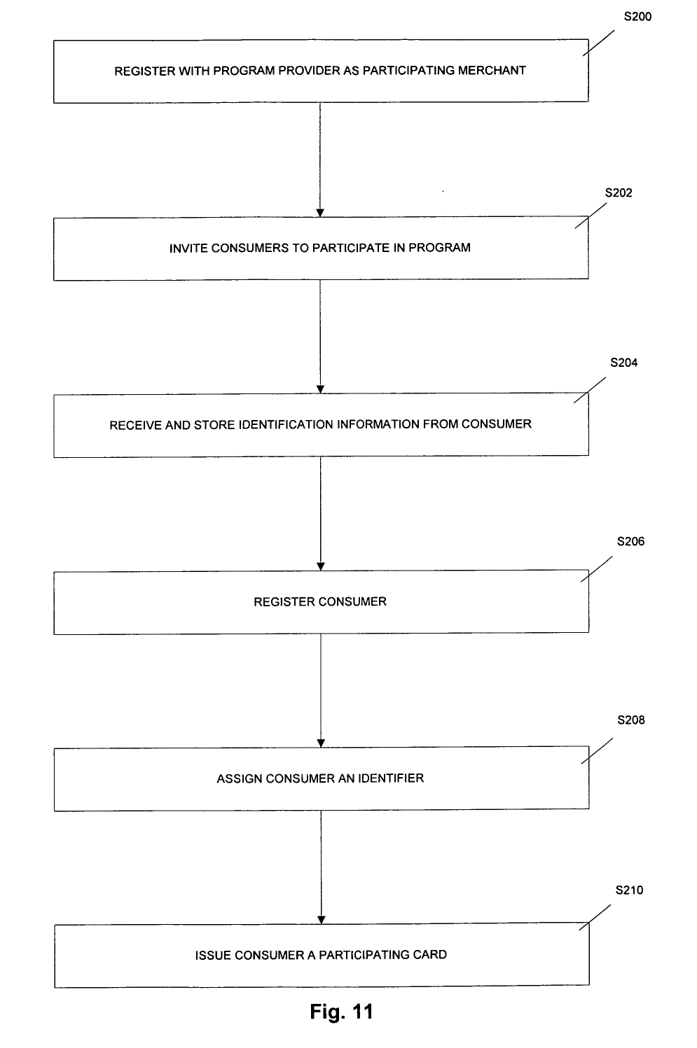

FIG. 11 is a flow chart that represents steps associated with a program provider 302 establishing consumers as participating in a program as defined herein.

In step S200, program provider 302 invites consumers to participate in a reward program, in accordance with the teachings herein, and to become participating consumers 306. This may be done, for example, by media advertising (e.g., television, radio, and printed publications), personally soliciting consumers in various merchants' store locations, or by advertising over the internet. In one embodiment, consumers may be offered an incentive, such as an initial number of free credits or some good/service, to become a participating consumer 306 as a sign-up bonus. Preferably, program provider 302 receives and stores information from a consumer, such as the consumer's name, e-mail address and/or contact information regarding the consumer (step S202).

Continuing with reference to the flowchart in FIG. 11, when in receipt of the consumer's information, program provider 302 registers the consumer as a participating consumer 306 (step S204). The consumer is preferably assigned a unique identifier (step S206), and a participating card 308 for use in recording transaction credits arising from purchases from participating merchants.

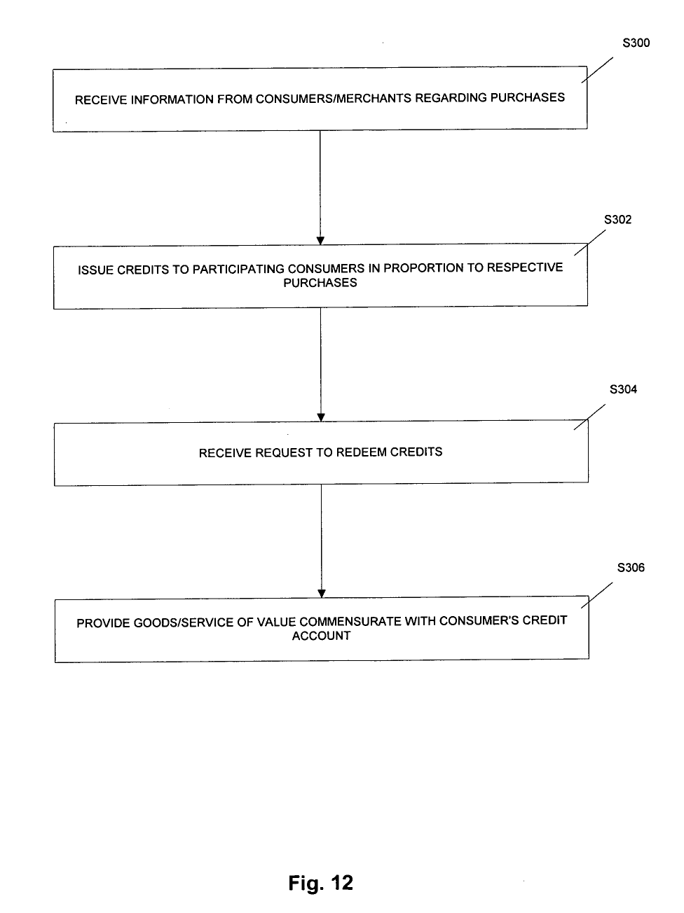

FIG. 12 is a flow chart that represents steps associated with a program provider 302 tracking purchases and maintaining consumer credit balances in accordance with an embodiment of the present invention.

In step S300, program provider 302 preferably receives information from a consumer 306 and/or merchant 304 (e.g., merchant 304a) regarding a purchase. For example, after a consumer 306 pays for an item from merchant 304a, he hands his card 308 to the merchant, who transmits information to program provider 302 identifying consumer 306 (e.g., by swiping card 308) and the respective purchase. Thereafter, program provider 302 issues a number of credits to consumer 306 corresponding to the respective purchase price (step S302). Eventually, program provider 302 receives a request from consumer 306 to redeem credits in his account for a good or service (step S304). Program provider identifies available goods/services for consumer 306, and provides a particular good/service in accordance with consumer's 306 selection (step S306). Alternatively, consumer 306 has no choice in the particular award, and simply receives a good and/or service (such as a rebate or a sweepstakes card and a chance for winning cash) from program provider 302.

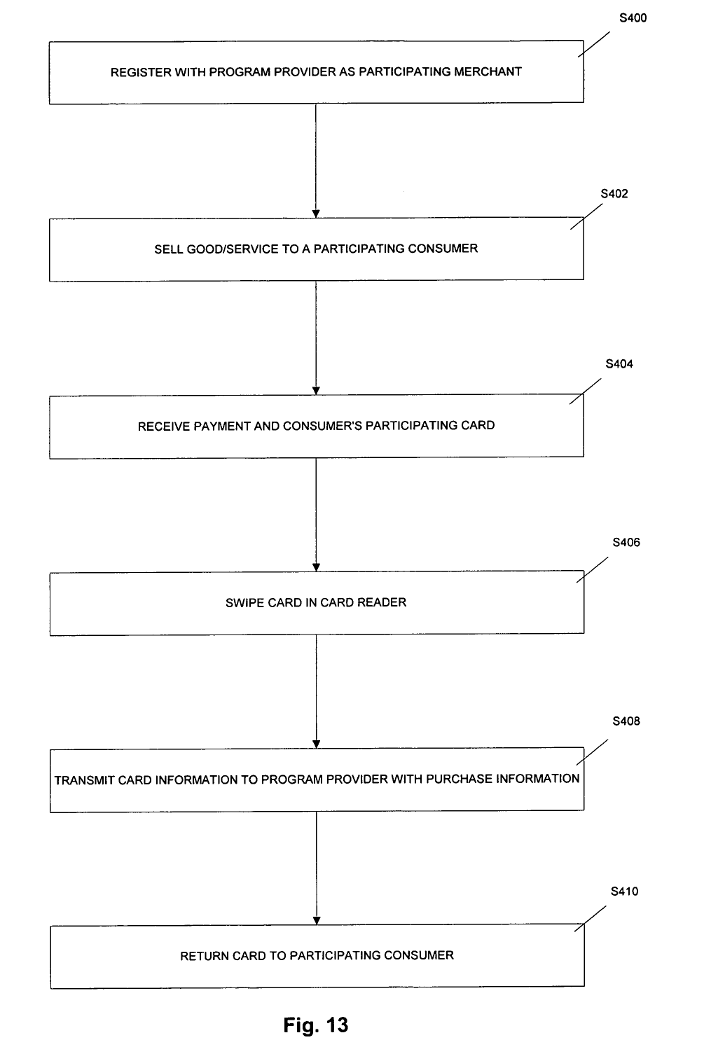

FIG. 13 is a flow chart that represents steps associated with a merchant 304 participating in a program in accordance with a preferred embodiment of the present invention.

In step S400, a merchant registers with program provider 302 and becomes a participating merchant. As described above, merchants preferably identify characteristics of themselves to program provider 302 in order to become members of one or more merchant groups. Once registered, as stated by participating merchant 304a of goods/services are made to a participating consumer 306 (step S402). During the sale, the merchant 304a receives cash, a credit card or other form of payment and consumer's participating (ID) card 308h (step S404). Merchant 304a accepts the payment and swipes card 308 in card reader 504 (step S406). Thereafter, merchant 304a transmits card information to program provider 302 with information regarding the purchase (e.g., the amount of the purchase) (step S408). Thereafter, consumer's 306 credit balance is updated, and the merchant returns card 308 to consumer 306 (step S410). Of course, one skilled in the art will recognize that, as noted above, purchase information can be transmitted to program provider 302 in various ways, including by consumer 306 logging into program provider's 302 information processor 2 and submitting purchase information in an on-line data entry form.

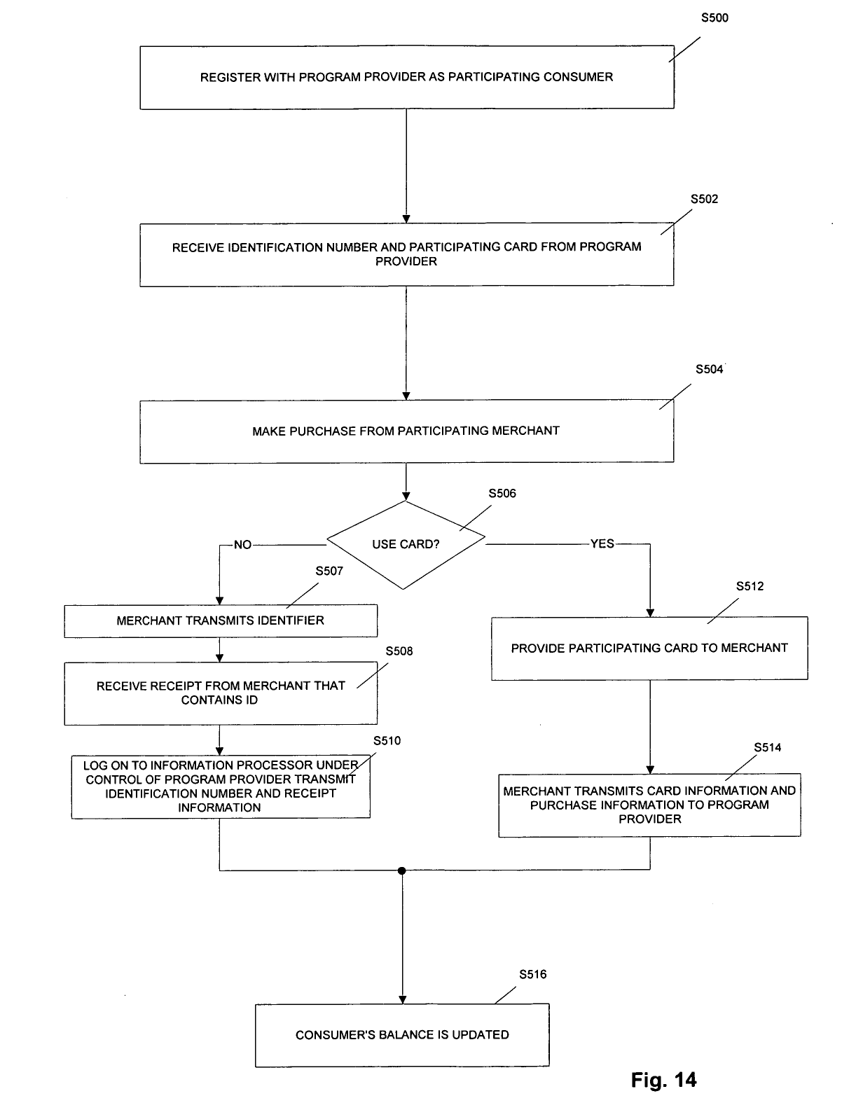

FIG. 14 is a flow chart that represents steps associated with a consumer 306 participating in a program in accordance with a preferred embodiment of the present invention.

In step S500, a consumer registers with program provider 302 to become a participating consumer 306. Consumer 306 receives from program provider 302 an identification number and a participating card 308 (step S502). Thereafter, consumer 306 makes a purchase from participating merchant (step S504). In step S506, a determination is made whether consumer 306 provides a card 308 to merchant 304. If not, then the process branches to step S508, and consumer 306 receives a receipt 508 from merchant that contains information regarding the purchase, such as the merchant's name, the amount of the purchase and a transaction identifier. The merchant transmits the identifier (step S507) so that consumer 306 can thereafter log on to information processor 2 under the control of program provider 302 and transmit information regarding the purchase (step S510). The transaction identifier transmitted by the purchaser is correlated with the one previously transmitted by the merchant as an authentication. This allows a purchaser who forgets this card 508 still to benefit from the transaction.

Continuing with reference to the flow chart in FIG. 14, if consumer 306 does provide card 508 to merchant 304, then the process branches to step S512 and merchant 304 transmits card information and purchase information to program provider at the point of sale. After program provider 302 receives information regarding the purchase along either branch following step S506, the consumer's credit balance is updated by issuing credits commensurate with the purchase (step S514). In step S516, the consumer's account balance is updated by program provider 302. Furthermore, purchases from a merchant 304 are tracked, thereby enabling program provider 302 to monitor sales made to a respective merchant 304. NOTE

As may now be appreciated, the present invention provides an improved way of encouraging people to use certain businesses over others that do not. Preferably, program provider 302 provides marketing services, such as cooperative or free advertising, and by providing logo 902, to draw people's attention to those merchants who are members of the provider's 302 program. Consumers 306 will receive a benefit by using participating merchants 304 businesses because consumers 306 earn credits that are redeemable for value. The number of credits held by consumer 306 preferably accumulates during purchases from participating merchants 304. Moreover, consumers 306 may purchase by using any means, such as cash, credit cards, checks, money orders or the like. Further, the present invention is applicable physical “brick and mortar” businesses, on-line businesses, TV shopping or any type of business. Those merchants who participate or partner with program provider 302 will benefit over non-participating merchants because of the increased likelihood that consumers 306 will patronize them. Other benefits include marketing efforts provided by program provider 302.

In a preferred embodiment, program provider 302 performs marketing efforts and tracks credits and awards of consumers 306 that patronize merchants 304. Program provider 302 may receive a fee from participating merchants as part of its revenue, and also profits from discounts on costs associated with redeemable goods and services, whereby the program provider 302 retains a larger percentage of its revenue from merchants. The amount may be a flat fee (depending on the size of the business) to a percentage of the sale or the amount of credits consumers 306 earn by patronizing a respective merchant 304. Thus, a merchant 304 that makes many sales to consumers 306 may pay more than a merchant 304 who makes very few sales to consumers 306.

Although the present invention has been described in relation to particular embodiments thereof, many other variations and modifications and other uses will become apparent to those skilled in the art. It is preferred, therefore, that the present invention be limited not by the specific disclosure herein.

What is claimed is:

1. A method for providing a marketing program for a selected group of merchants which provides incentives to consumers to purchase goods and/or services from the selected group of merchants, the method comprising:
establishing a merchant selection rule that includes a criterion a merchant is required to meet to join the selected group of merchants;
registering a consumer wishing to participate in the program;
receiving merchant information from merchants who desire to join the selected group of merchants, the merchant information including characteristics of the respective merchants;
matching the received merchant information with the merchant selection rule and adding merchants to the selected group of merchants after determining that the respective merchants meet the required criterion;
providing a machine readable database on a communication network operable to store information representing earned credits for participating consumers resulting from transactions between participating consumers and participating merchants;
providing access for participating merchants and participating consumers to update the database with the specified information for a particular transaction, the access being independent of the method of payment for goods and/or services and independent of where the goods and/or services are offered for sale;
storing in the database information as to available incentives and respective values for the incentives relative to individual and/or cumulative value of transactions; and
providing access to the database for participating consumers to select incentives according to earned credits from purchases from the selected group of merchants.

2. The method of claim 1, wherein the incentives include sweepstakes cards enabling a participating consumer to win money.

3. The method of claim 2, wherein an amount provided by the sweepstakes cards is related to the amount of the consumer's earned credits.

4. The method of claim 1, further comprising providing a logo to the selected group of merchants to be displayed by the selected group of merchants.

5. The method of claim 1, further comprising advertising the marketing program.

6. The method of claim 5, wherein the advertising is provided at least in printed media, television, radio, and/or over the internet.

7. The method of claim 1, further comprising receiving consumer information from consumers, wherein the consumer information includes an identification of the consumer's registration.

8. The method of claim 7, further comprising providing a survey to consumers to receive information from participating consumers, and awarding the participating consumers credits for completing the survey.

9. The method of claim 1, further comprising charging the selected group of merchants a fee for participating in the marketing program.

10. The method of claim 9, wherein the fee comprises a flat fee entitling merchants to join the selected group for a period of time.

11. The method of claim 9, wherein the fee comprises a royalty percentage of each sale made to participating consumers.

12. The method of claim 1, further comprising establishing a second merchant selection rule that includes a different criterion a merchant must meet to join a second selected group of merchants.

13. The method of claim 12, wherein the merchant has concurrent membership in both the first selected group and the second selected group of merchants.

14. The method of claim 1, further comprising using an ID card to provide access to the database for recording a transaction.

15. The method of claim 14, further comprising providing a transaction identifier to use for later access when the ID card is not available at the time of the transaction.

16. The method of claim 15, wherein the merchant sends the transaction identifier to a database for later use in authentication.

17. The method of claim 1, wherein the merchant information is received in machine readable form.

18. An apparatus for providing a marketing program for a selected group of merchants which provides incentives to consumers to purchase goods and/or services from the selected group of merchants, the apparatus comprising:
a merchant selection rule that includes a criterion a merchant is required to meet to join the selected group of merchants;
a registration module that registers a consumer wishing to participate in the program;
a merchant information reception module that receives merchant information from merchants who desire to join the selected group of merchants, the merchant information including characteristics of the respective merchants;
a matching module that matches the received merchant information with the merchant selection rule and adds merchants to the selected group of merchants after determining that the respective merchants meet the required criterion;
a machine readable database provided on a communication network operable to store information representing earned credits for participating consumers resulting from transactions between participating consumers and participating merchants;
an interface that provides access for participating merchants and participating consumers to update the database with the specified information for a particular transaction, the access being independent of the method of payment for goods and/or services and independent of where the goods and/or services are offered for sale;
wherein information is stored in the database as to available incentives and respective values for the incentives relative to individual and/or cumulative value of transactions; and wherein access to the database is provided for participating consumers to select incentives according to earned credits from purchases from the selected group of merchants.

19. The apparatus of claim 18, wherein the incentives include sweepstakes cards enabling a participating consumer to win money.

20. The apparatus of claim 19, wherein an amount provided by the sweepstakes cards is related to the amount of the consumer's earned credits.

21. The apparatus of claim 18, further comprising a logo provided to the selected group of merchants to be displayed by the selected group of merchants.

22. The apparatus of claim 18, further wherein the marketing program is advertised.

23. The apparatus of claim 22, wherein the advertising is provided in at least printed media, television, radio, and/or over the internet.

24. The apparatus of claim 18, further comprising a consumer information reception module that receives consumer information from consumers, wherein the consumer information includes an identification of the consumer's registration.

25. The apparatus of claim 24, further a survey provided to consumers to receive information from participating consumers, and credits awarded to the participating consumers for completing the survey.

26. The apparatus of claim 18, wherein selected group of merchants is charged a fee for participating in the marketing program.

27. The apparatus of claim 26, wherein the fee comprises a flat fee entitling merchants to join the selected group for a period of time.

28. The apparatus of claim 26, wherein the fee comprises a royalty percentage of each sale made to participating consumers.

29. The apparatus of claim 18, further comprising a second merchant selection rule that includes a different criterion a merchant must meet to join a second selected group of merchants.

30. The apparatus of claim 29, wherein the merchant has concurrent membership in both the first selected group and the second selected group of merchants.

31. The apparatus of claim 19, further comprising an ID card that provides access to the database for recording a transaction.

32. The apparatus of claim 31, further comprising a transaction identifier to use for later access when the ID card is not available at the time of the transaction.

33. The apparatus of claim 32, wherein the merchant sends the transaction identifier to a database for later use in authentication.

34. The apparatus of claim 19, wherein the merchant information received is provided in machine readable form.
